(19) United States
(12) Patent Application Publication
(10) Pub. No.: US 2014/0045084 A1
(43) Pub. Date: Feb. 13, 2014

(54) INTERNAL STEAM GENERATION FOR FUEL CELL

(71) Applicant: Sitaram Ramaswamy, West Hartford, CT (US)

(72) Inventor: Sitaram Ramaswamy, West Hartford, CT (US)

(73) Assignee: United Technologies Corporation, Hartford, CT (US)

(21) Appl. No.: 14/113,617

(22) PCT Filed: Apr. 26, 2011
(86) PCT No.: PCT/US2011/033848

§ 371 Date: Oct. 24, 2013

(51) Int. Cl. H01M 8/06; H01M 8/04

(52) U.S. Cl. CPC H01M 8/0618; H01M 8/04029
USPC 429/423; 429/437

(57) ABSTRACT

A fuel cell system includes a fuel cell stack having an anode plate and a cathode plate arranged on opposing sides of a proton exchange membrane. Cooling channels are in thermal contact with at least one of the anode plate and the cathode plate and include an internal coolant passage. A pressure-drop device is provided in the coolant channels and is configured to provide a sub-atmospheric pressure within the coolant passage. In one example, the coolant within the coolant passage is at less than ambient pressure. A compression device fluidly interconnects to and is downstream from the internal coolant passage by a coolant system loop and configured to convey a sub-atmospheric pressure coolant steam. The compression device is configured to increase the pressure and a temperature of the sub-atmospheric coolant steam to a super-atmospheric pressure and maintain the coolant steam within a steam region of a pressure-enthalpy curve.

### BACKGROUND

This disclosure relates to a fuel cell system. More particularly, the disclosure relates to a method and apparatus for generating steam within a fuel cell stack of a fuel cell system.

One typical fuel cell system includes a fuel cell stack having an anode plate and a cathode plate arranged on either side of a proton exchange membrane. The fuel stack also typically includes coolant channels, which circulates coolant in a coolant loop within the fuel cell system. One typical coolant is water.

Some fuel cell stacks produce coolant at temperatures below boiling point with the coolant ambient pressure with the fuel cell stack. Thus, no steam is produced inside such a fuel cell stack. To produce steam under such conditions, one example fuel cell system incorporates a valve and a flash evaporator arranged externally of the fuel cell stack to convert the low temperature coolant to steam. The steam is then used in a fuel reformation system.

### SUMMARY

A fuel cell system includes a fuel cell stack having an anode plate and a cathode plate arranged on opposing sides of a proton exchange membrane. Cooling channels are in thermal contact with at least one of the anode plate and the cathode plate and include an internal coolant passage. A pressure-drop device is provided in the coolant channels and is configured to provide a sub-atmospheric pressure within the coolant passage. A compression device fluidly interconnects to and is downstream from the internal coolant passage by a coolant system loop and configured to convey a sub-atmospheric pressure coolant steam. The compression device is configured to increase the pressure and a temperature of the sub-atmospheric coolant steam to a super-atmospheric pressure and maintain the coolant steam within a steam region of a pressure-enthalpy curve.

A method of producing steam within the fuel cell system includes a step of creating a pressure drop within a fuel cell stack to lower the boiling point of coolant within the fuel cell stack. The coolant is boiled within the fuel cell stack to produce steam. The steam is supplied to a component outside of the fuel cell stack via a coolant steam loop.

### BRIEF DESCRIPTION OF THE DRAWINGS

The disclosure can be further understood by reference to the following detailed description when considered in connection with the accompanying drawings wherein:

FIG. 1 is a highly schematic view of an example fuel cell system with steam generation internal to the fuel cell stack.

FIG. 2A is a schematic view of one example fuel cell stack.

FIG. 2B is a schematic view of another example fuel cell stack.

FIG. 2C is a schematic view of yet another example fuel cell stack.

FIG. 2D is a schematic view of still another example fuel cell stack.

FIG. 3 is a schematic view of another example fuel cell system having steam generation internal to the fuel cell stack.

### DETAILED DESCRIPTION

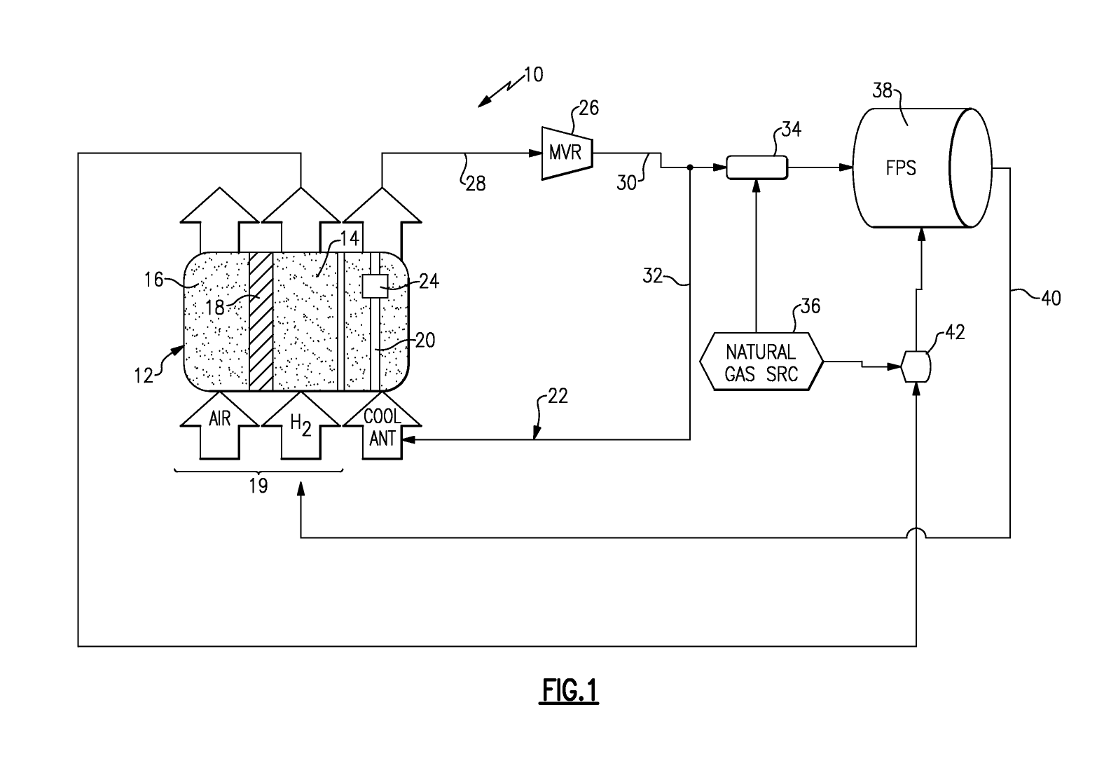

A fuel cell system 10 is schematically illustrated in FIG. 1. The system 10 includes a fuel cell stack 12 having multiple cells 19 stacked relative to one another to produce a desired amount of electricity. Each cell 19 includes an anode plate 14 and a cathode plate 16 arranged on opposing sides of a proton exchange membrane 18, which is part of a unitized electrode assembly, for example.

Coolant channels 20 are arranged throughout the fuel cell stack 12, typically between the cells 19. A coolant loop 22 is in fluid communication with the coolant channels 20 and circulates a coolant, water in one example, throughout the system 10 to regulate the temperature of the fuel cell stack 12. The coolant may also be used for other purposes within the system 10, as needed.

Some low temperature fuel cell applications operate at a temperature that heats the coolant to less than 100° C. With water as the coolant, steam will not be generated under these conditions. However, steam can be useful within the system 10. To this end, the system 10 includes a pressure drop device 24 arranged internally to the fuel cell stack 12. As schematically illustrated in FIG. 1, the coolant channels 20 provide an internal coolant passage with the pressure drop device 24 to lower the pressure of the coolant to the point at which it will boil and produce steam inside the fuel cell stack 12.

In the example, the coolant loop 22 includes a first coolant steam line 28 that conveys sub-atmospheric pressure steam to a compression device 26. The compression device 26 compresses the sub-atmospheric pressure steam, thus, also raising its temperature, to produce super-atmospheric pressure steam (for example, to 1.1 atmospheres and 150° C.) that is conveyed through a second coolant steam line 30 to a junction 34.

A fuel source 36 supplies fuel to the junction 34, which intermixes the fuel and the super-atmospheric pressure coolant steam to provide a mixture. The mixture from the junction 34 is supplied to a fuel processing system 38 that produces reformate, which is provided to the anode plate 14 via a reformate line 40. The fuel source 36 may also provide fuel to a burner 42, which drives, in part, the fuel processing system 38. Unused coolant may be returned to the coolant channels 20 through a coolant return line 32.

The compression device 26 maintains the coolant steam within a steam region of a pressure-enthalpy curve. By generating the steam at sub-atmospheric pressures within the fuel cell stack, the sub-atmospheric pressure coolant steam can be quasi-isentropically compressed by the compression device.

The compression device 26, which may be a scroll compressor, for example, can be driven by an electric motor. The additional efficiency enabled by generating the steam internally within the fuel cell stack, rather than externally, is sufficient to provide an overall fuel cell efficiency increase despite the losses associated with the compression device.

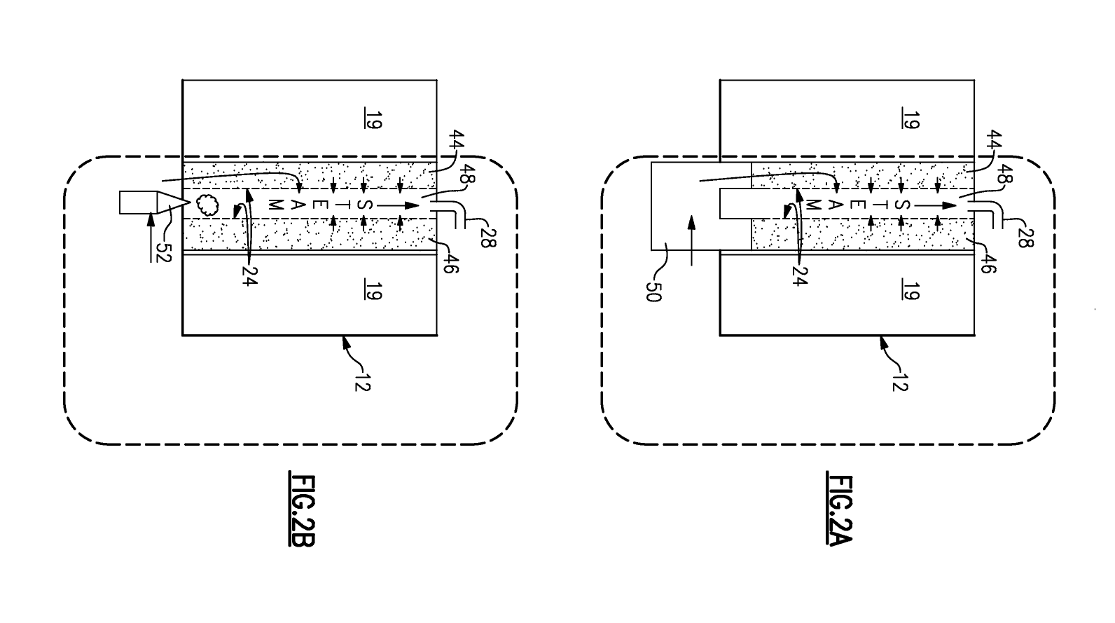

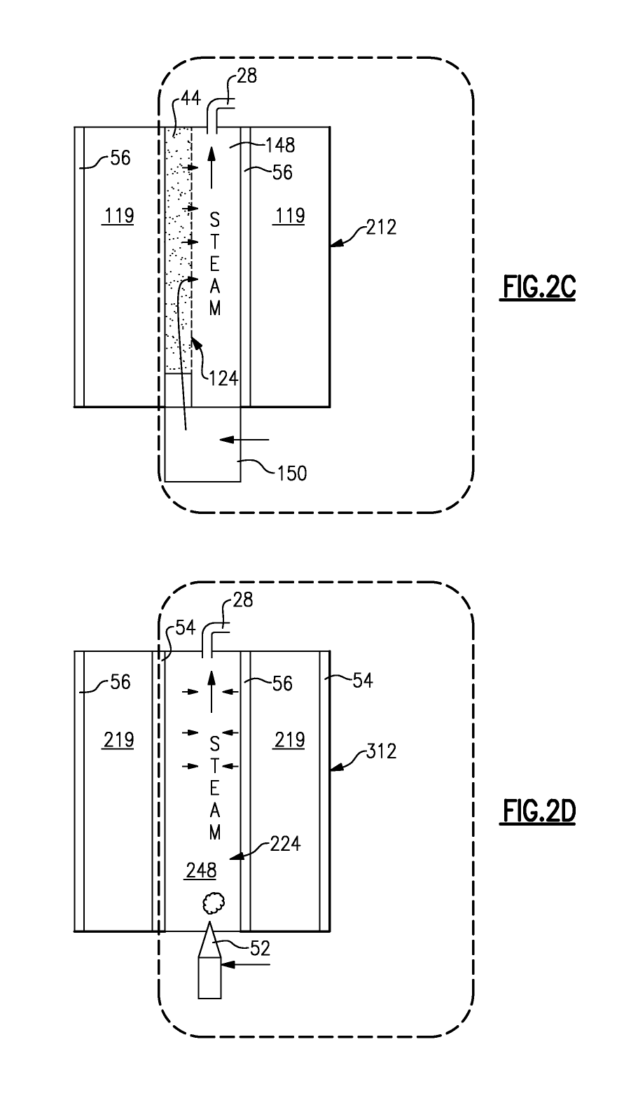

An example fuel cell stack 12 is illustrated in FIG. 2A. In the example, the anode and cathode plates provide first and second porous layers 44, 46. An internal coolant passage 48 is provided between the first and second porous layers 44, 46. A coolant manifold 50 provides coolant to the first and second porous layers 44, 46 for desired humidification during fuel cell operation. Passage of processed water through the porous layers 44, 46 during fuel cell operation provides the pressure drop device 24, which enables the coolant that is at a temperature less than 100° C. to boil in the sub-atmospheric pressure.

Another example fuel cell stack 112 is illustrated in FIG. 2B. In this example, a spray nozzle 52 is used to provide droplets of water to the internal coolant passage 48, which will become steam in the sub-atmospheric pressures within the coolant passage 48 created by the porous layers.

Another fuel cell stack 212 is illustrated in FIG. 2C. The fuel cell stack 212 includes cell 119 having the first porous layer 44 and a second solid plate 56. That is, a porous plate provides one of the anode and cathode plates, and a solid plate provides the other plate. The coolant supplied by the coolant manifold 150 humidifies the first porous layer 44, which provides the pressure drop device 124. Steam is generated in the sub-atmospheric pressures.

Referring to FIG. 2D, a fuel cell stack 312 includes cells 219 that utilize first and second solid plates 54, 56. The internal coolant passage 248 is configured to provide a sub-atmospheric pressure, for example, by introducing restrictions in the coolant channels. Water droplets are introduced by the spray nozzle 52. The water is converted to steam in the sub-atmospheric pressure within the internal coolant passage 248.

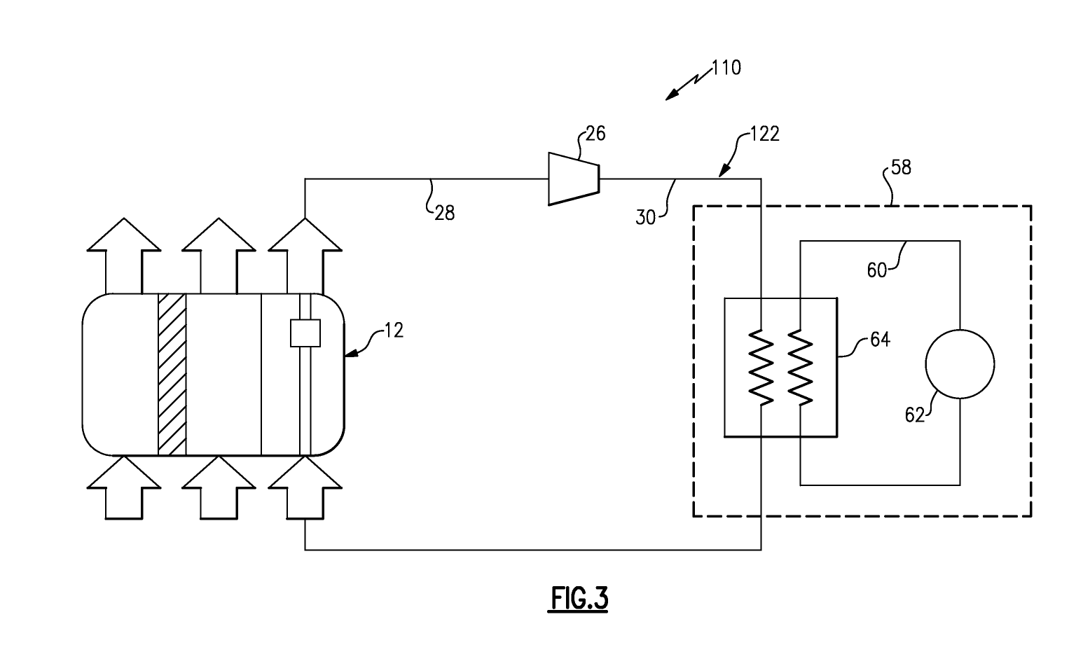

Another fuel cell system 110 is illustrated in FIG. 3. The coolant loop 122 generates steam in the same manner as described relative to FIG. 1 above. The system 110 cooperates with a fluid loop 60 of a building 58, for example, to transfer heat from the coolant loop 122 to the fluid loop 60 via a heat exchanger 64. Heat is transferred between the coolant loop 122 and the fluid loop 60 to achieve a desired temperature of fluid within the fluid loop 60 for a building sub-system 62, for example, such as a building hot water system.

Although an example embodiment has been disclosed, a worker of ordinary skill in this art would recognize that certain modifications would come within the scope of the claims. For that reason, the following claims should be studied to determine their true scope and content.

What is claimed is:

1. A fuel cell system comprising:
a fuel cell stack including an anode plate and a cathode plate arranged on opposing sides of a proton exchange membrane, and coolant channels including an internal coolant passage in thermal contact with at least one of the cathode and anode plates;
a pressure drop device provided in the coolant channels and configured to provide a sub-atmospheric pressure within the coolant passage; and
a compression device fluidly interconnect to and downstream from the internal coolant passage by a coolant steam loop configured to convey a sub-atmospheric pressure coolant steam, the compression device configured to increase the pressure and a temperature of the sub-atmospheric coolant steam to a super-atmospheric pressure and maintain the coolant steam within a steam region of a pressure-enthalpy curve.

2. The fuel cell system according to claim 1, wherein the coolant channels are provided by a porous layer of at least one of the anode plate and the cathode plate.

3. The fuel cell system according to claim 2, wherein the porous layer provides the pressure drop device.

4. The fuel cell system according to claim 3, comprising a spray nozzle arranged in the coolant passage configured to provide spray water droplets into the coolant passage for conversion to the coolant steam.

5. The fuel cell system according to claim 1, wherein the coolant channels are provided by a solid non-porous plate provided by at least one of the anode plate and the cathode plate.

6. The fuel cell system according to claim 5, comprising a spray nozzle arranged in the coolant passage configured to provide spray water droplets into the coolant passage for conversion to the coolant steam.

7. The fuel cell system according to claim 1, wherein the compression device includes a scroll compressor.

8. The fuel cell system according to claim 1, comprising a fuel source in fluid communication with the coolant steam loop at a junction via a fuel supply line, the junction downstream from the compression device and configured to intermix a fuel and the super-atmospheric pressure coolant steam to provide a mixture.

9. The fuel cell system according to claim 8, comprising a fuel processing system in fluid communication with the junction and configured to receive the mixture, the fuel processing system fluidly interconnected to the anode plate via a reformate line and configured to provide a reformate thereto through the reformate line.

10. The fuel cell system according to claim 1, wherein the fuel cell stack is configured to operate at an equilibrium operating condition providing an internal cell stack coolant temperature of less than 100° C.

11. The fuel cell system according to claim 1, comprising a building fluid loop, and a heat exchanger including the building fluid loop and the coolant steam loop configured to transfer heat there between.

12. The fuel cell system according to claim 1, wherein the coolant steam is configured to undergo quasi-isentropic compression in the compression device in comparison to an entropy of the coolant steam within the fuel cell stack.

13. A method of producing steam within a fuel cell system comprising:
creating a pressure drop within a fuel cell stack to lower the boiling point of coolant within the fuel cell stack;
boiling the coolant within the fuel cell stack to produce steam; and
supplying the steam to a component outside of the fuel cell stack via a coolant steam loop.

14. The method according to claim 13, wherein the creating step includes providing a coolant temperature within the stack of less than 100° C. and a pressure of less than atmospheric pressure.

15. The method according to claim 13, wherein the supplying step includes quasi-isentropically compressing the steam, in comparison to an entropy of the steam within the fuel cell stack, to a pressure greater than atmospheric pressure and maintaining the steam within a steam region of a pressure-enthalpy curve.
